(19) United States
(12) Patent Application Publication
(10) Pub. No.: US 2010/0134954 A1
(43) Pub. Date: Jun. 3, 2010

(54) ELECTRODES FOR ELECTROCHEMICAL CELLS

(75) Inventors: Chris Wright, Oxford (GB); Jennifer Sweeney, Tadley (GB); Daniel Peat, Southampton (GB); Philip Andrew Nelson, Southampton (GB)

Correspondence Address: FOLEY & LARDNER LLP, P.O. BOX 80278, SAN DIEGO, CA, 92138-0278, US

(73) Assignee: Nanotecture Ltd.

(21) Appl. No.: 12/447,227

(22) PCT Filed: Oct. 24, 2007
(86) PCT No.: PCT/GB2007/004060

§ 371 Date: Jan. 5, 2010

(30) Foreign Application Priority Data
Oct. 25, 2006 (GB) 0621255.9

(51) Int. Cl. H01G 9/058

(52) U.S. Cl. 361/502

(57) ABSTRACT

A hybrid supercapacitor comprises a double layer electrode and a redox electrode, in which the ratio of the volumes, and hence the thicknesses, of the two electrodes is significantly higher than previously considered optimum, specifically from 9:1 to 100:1.

The present invention relates to improvements in the electrode arrangements for electrochemical cells, especially electrochemical cells intended for use as hybrid supercapacitors.

A hybrid supercapacitor is a capacitive energy storage device that employs two different electrode types, this difference generally being in electrode capacity or composition. Most commonly, one electrode is a redox (faradaic) electrode and the other a double layer (non-faradaic) electrode.

According to earlier art (U.S. Pat. No. 6,222,723), it is advantageous for a hybrid supercapacitor to be constructed such that the absolute capacitance of the redox electrode is more than three times, and preferably ten times, the absolute capacitance of the double layer electrode, or vice versa. This is generally achieved by using different materials, one of which has a significantly greater specific capacitance than the other, so that the actual physical sizes of the electrodes are substantially the same or even the electrode with the larger capacitance may be smaller than the other electrode. Based on a knowledge of the behaviour of capacitance in series circuits, it is argued that generally this leads to optimal energy density performance expressed as either gravimetric or volumetric energy density. In practice, the extra absolute capacitance in the redox electrode is also required since conventional redox electrodes generally suffer considerably sharper reductions in available capacity at high discharge rates (from the capacity levels available at low discharge rates) than do the opposing double layer electrodes. In addition, conventional redox electrodes are typically characterised by significantly poorer cycle life (capable of hundreds of cycles) than double layer electrodes (capable of hundreds of thousands of cycles). As a result, in order to achieve the high cycle life (tens or hundreds of thousands of cycles) demanded by supercapacitor applications, the redox electrode has to be oversized such that the extent to which it is discharged is reduced, prolonging its life (‘shallow’ cycling is a significantly less harsh condition than ‘deep’ cycling). Since the redox and double layer electrodes generally share the same footprint area, oversizing of the redox electrode is manifest as increased thickness. As an indication, U.S. Pat. No. 5,986,876 exemplifies a nickel/carbon hybrid supercapacitor in which the carbon to nickel electrode thickness ratio is 1:1.

To insert a supercapacitor into a portable electronic product it is usually advantageous to maximise the volumetric energy density since only a small volume is available; and, according to theory, this is best achieved for high ratios of the capacitance per unit volume of the two electrodes and volume fractions within a limited range. For example, when the ratio of the capacitances per unit volume is between 10:1 and 20:1, the preferred volume fraction of the electrode with the lower capacitance per unit volume is between 0.6 and 0.9, or more preferably between 0.7 and 0.9. Furthermore, according to theory, when the ratio of the capacitances per unit volume is between 10:1 and 20:1, values of volume fraction of the electrode with the lower capacitance per unit volume greater than 0.9 are strongly disfavoured. In general, conventional hybrid supercapacitors tend to employ a volume fraction of from 0.5 to 0.8. The “volume fraction” is the fraction of the total electrode volume occupied by the electrode with the lower capacitance per unit volume. Thus, with a volume fraction of 0.9, the ratio of the volumes of the electrodes is 9:1. In a smart card, for example, the supercapacitor generally has to be less than approximately 600 micrometers in thickness. Furthermore, when using a nickel/carbon hybrid supercapacitor, in order to obtain a high voltage (higher than the 1.5 V available from an individual cell) for example, 3 V, there are further constraints on the thickness of an individual cell, as multiple cells must be used in series to give the desired voltage. Where the desired voltage is 3 V and restrictions on the cell footprint area mean that series cells must be stacked, the thickness of a nickel/carbon supercapacitor cannot exceed approximately 300 micrometers. In this case the use of conventional hybrid supercapacitor technologies with their excessively voluminous redox electrodes becomes unfeasible. Features which are considered highly beneficial in a supercapacitor, especially one for use in applications such as in a smart card, are a high value of the volumetric charge storage capacity and an ability to deliver a constant voltage output during discharge.

We have now surprisingly found that, by using a high performance porous redox electrode, there exists an optimum structure in which the ratio of the volumes, and hence the thicknesses, of the two electrodes lies outside what would previously have been thought of as a preferred range. In fact, we have found that significantly higher double layer electrode to redox electrode thickness ratios are optimum (correspondingly, this means that the preferred ratio of absolute capacitance is less than the 3:1 ratio claimed in U.S. Pat. No. 6,222,723) and the preferred volume fraction, when the ratio of the capacitances per unit volume is between 10:1 and 20:1, lies in the range from 0.9 to 0.99. In this context, the optimum is the best balance of maximal volumetric charge storage capacity with the ability to deliver as constant a voltage over as long a period as possible.

Thus, the present invention consists in a hybrid supercapacitor comprising: at least one double layer electrode; at least one redox electrode; current collectors; at least one separator; and an electrolyte, characterised in that the ratio of the total volume of the double layer electrode or electrodes to the total volume of the redox electrode or electrodes is from 9:1 to 100:1.

The invention is further illustrated by reference to the accompanying drawings, in which:

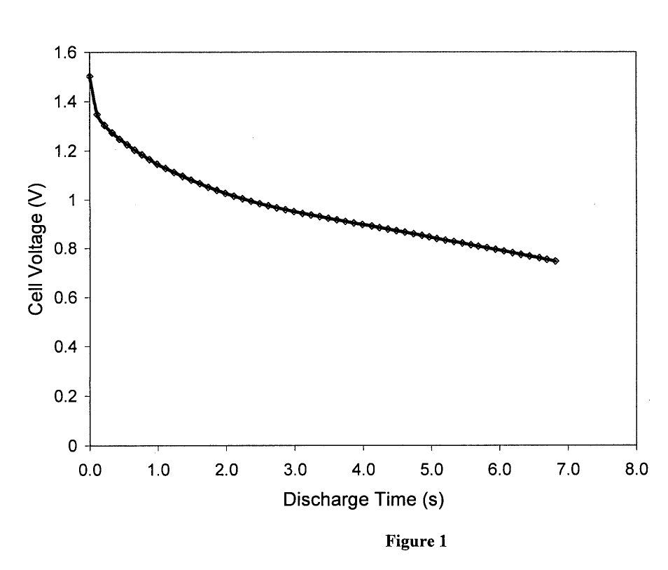

FIG. 1 shows a plot of voltage versus time at a cell discharge rate of 5220 mA/cc for the cell whose construction is illustrated in Example 1;

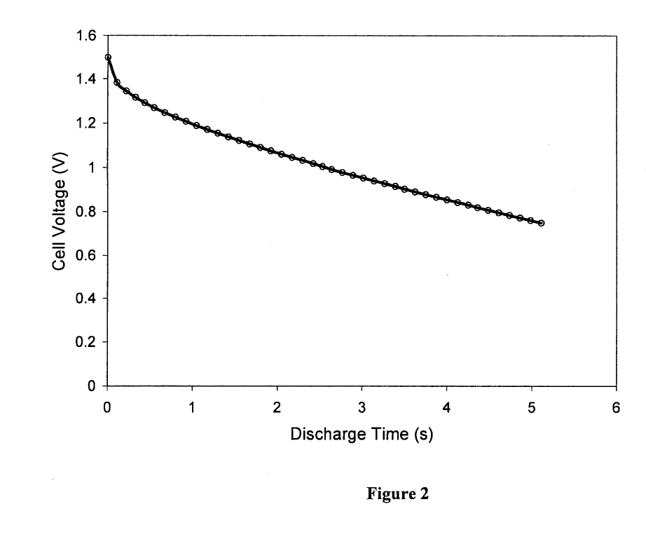

FIG. 2 shows a plot of voltage versus time at a cell discharge rate of 4984 mA/cc for the cell whose construction is illustrated in Example 2; and

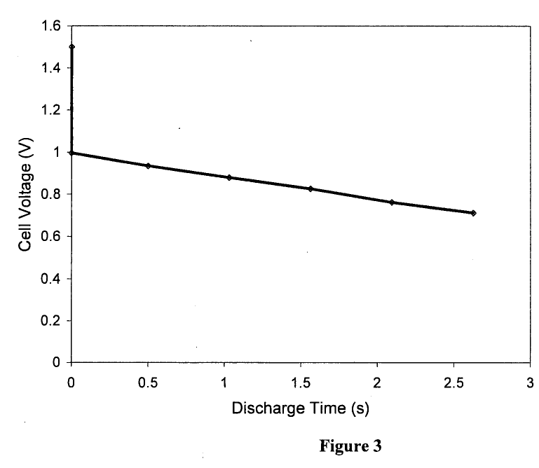

FIG. 3 shows a plot of voltage versus time at a cell discharge rate of 4986 mA/cc for the cell whose construction is illustrated in Example 3.

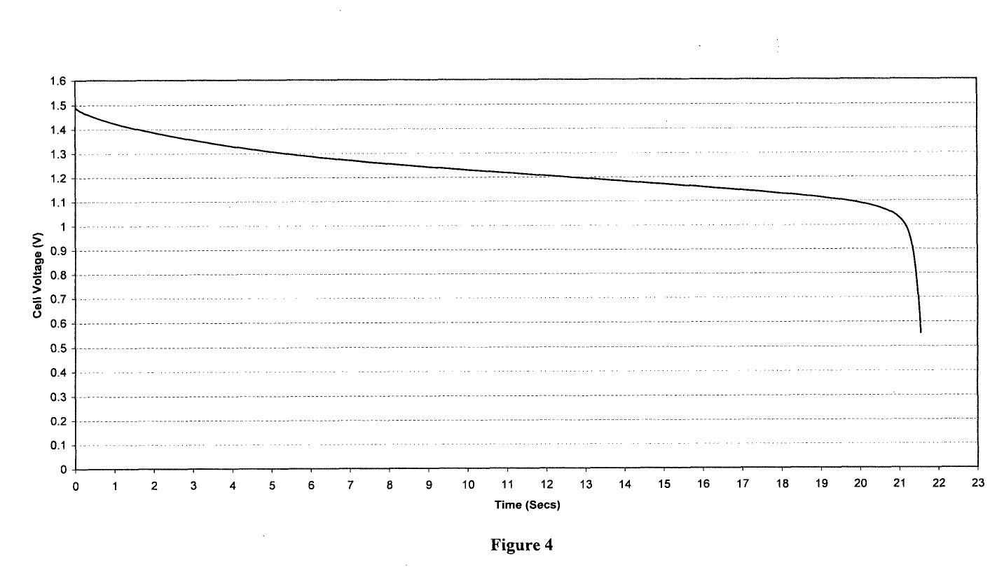

FIG. 4 shows a plot of voltage versus time at a cell discharge rate of 1400 mA/cc for the cell whose construction is illustrated in Example 1

Where, as is often preferred, the electrodes have similar or the same footprints, then the ratio of the total thickness of the double layer electrode or electrodes to the total thickness of the redox electrode or electrodes is from 9:1 to 100:1. If there is simply one redox electrode and one double layer electrode, then the ratio of the volumes or thicknesses of these two electrodes is all that matters. Where there is more than one of one or both types of electrode, then the sum of the volumes or thicknesses of the electrodes of the same type are important.

To maximise performance defined in terms of optimising all the above quoted features, we have found that the double layer electrode to redox electrode volume (or thickness) ratios should suitably be in the range from greater than 9:1 to 100:1 with a preferred range of from 10:1 to 100:1, more preferably from 10:1 to 50:1, and most preferably from 15:1 to 50:1. It should be noted that, where the electrode material and current collector are two separate, but connected, entities, the volume (or thickness) referred to considers the active electrode material only, that is, without the current collector. Where the active material and current collector do not exist as two separate layers (that is, where the active material fills the pores of a porous current collector such as nickel foam), volume (or thickness) refers to the volume (or thickness) of the entire body. It should also be noted that, where the supercapacitor is a bi-cell with, for example, two double layer electrodes either side of a redox electrode, then both double layer electrodes need to be included in the volume fraction calculation.

The ratio of capacitance per unit volume of the double layer electrode to the redox electrode is preferably from 1:10 to 1:20, more preferably from 1:12 to 1:20.

The advantage of using an ultra-thin redox electrode is that the redox electrode is thinner and lighter than conventional redox electrodes, increasing the volumetric energy density of the cell and making application in volume sensitive electronics devices possible. Moreover, the cell is capable of delivering a constant voltage over a significant portion of its discharge life, thus enhancing its utility in a wide range of applications. Furthermore, the combination of advantages described would also be thought of as positive in larger automotive cells due to the increased energy density (volumetric and gravimetric).

The invention further provides a hybrid supercapacitor comprising: at least one double layer electrode; at least one redox electrode; current collectors; at least one separator; and an electrolyte, characterised in that the redox electrode or electrodes each has a total active layer thickness in the range from 5 to 100 μm, preferably from 10 to 70 μm, more preferably from 10 to 30 μm.

The redox electrode employed in the present invention is preferably a mesoporous metal or metal compound, especially a metal, a metal oxide, a metal hydroxide, a metal oxy-hydroxide or a combination of any two or more of these. Examples of such metals include: nickel; alloys of nickel, including alloys with a transition metal, nickel/cobalt alloys and iron/nickel alloys; tin; alloys of tin, including alloys with a transition metal; cobalt; titanium; alloys of titanium, including alloys with a transition metal; platinum; palladium; lead; alloys of lead, including alloys with a transition metal and ruthenium. Examples of such oxides, hydroxides and oxy-hydroxides include: palladium oxide; nickel oxide (NiO); nickel hydroxide (Ni(OH)₂); nickel oxy-hydroxide (NiOOH); lead dioxide (PbO₂); cobalt oxide (CoO₂) and its lithiated form (LiCoO₂); titanium dioxide (TiO₂) and its lithiated form (LiₓTiO₂); titanium oxide (Ti₅O₁₂) and its lithiated form (LiₓTi₅O₁₂) and ruthenium oxide. Of these, we most prefer nickel and its oxides, hydroxides and oxyhydroxides, especially nickel or a nickel/cobalt mixture.

The mesoporous material used as the redox electrode is preferably formed by a liquid crystal deposition process, such as is described in EP 993 512 or U.S. Pat. No. 6,203,925.

The mesoporous materials used in the present invention are sometimes referred to as “nanoporous”. However, since the prefix “nano” strictly means 10⁻⁹, and the pores in such materials normally range in size from 10⁻⁸ to 10⁻⁹ m, it is better to refer to them, as we do here, as “mesoporous”.

The double layer (non-faradaic) electrode may be of any material commonly used in the art for this purpose, for example carbon cloth, activated carbons, carbon black, or carbons derived from silicon carbide or titanium carbide precursors. The double layer electrode may also be made of a mesoporous material or a conventional material.

By “mesoporous structure”, “mesoporous material” and “mesoporous film” as referred to herein are meant structures, materials and films, respectively, that are preferably fabricated via a liquid crystal templating process, and can contain a long range, regular arrangement of pores having a defined topology and a substantially uniform pore size (diameter). Accordingly, the mesoporous structures, materials and films may also be described as nanostructured or having nanoarchitecture.

Therefore, the mesoporous materials used in accordance with the invention are distinct from poorly crystallised materials and from composites with discrete nano-sized solid grains, e.g. conventionally denoted ‘nanomaterials’ that are composed of aggregated nanoparticulates.

An advantage of using mesoporous materials, compared with nanomaterials, is that electron transport within the mesoporous material encounters lower grain boundary resistances, affording superior electronic conductivity and reducing power losses associated with this phenomenon. Moreover, the ordered porosity of the mesoporous materials used here provides a relatively continuous and straight, non-tortuous path of flow with uniform diameter, encouraging the rapid and unhindered movement of electrolyte species. By contrast, conventional nanoparticulate systems have a disordered porosity with voids of varying cross section interconnected by narrower inter-void spaces. As such, substances moving within the pore structure encounter a considerably tortuous path, impeding reaction rates.

The mesoporous material is preferably in the form of a film of substantially constant thickness. Preferably, the mesoporous film thickness is in the range from 10 to 30 micrometers.

Preferably, the mesoporous material has a pore diameter within the range from about 1 to 10 nanometres, more preferably within the range from 2.0 to 8.0 nm.

The mesoporous material may exhibit pore number densities in the range from 1×10¹⁰ to 1×10¹⁴ pores per cm², preferably from 4×10¹¹ to 3×10¹³ pores per cm², and more preferably from 1×10¹² to 1×10¹³ pores per cm².

The mesoporous material has pores of substantially uniform size. By “substantially uniform” is meant that at least 75%, for example 80% to 95%, of pores have pore diameters to within 30%, preferably within 10%, and most preferably within 5%, of average pore diameter. More preferably, at least 85%, for example 90% to 95%, of pores have pore diameters to within 30%, preferably within 10%, and most preferably within 5%, of average pore diameter.

The pores are preferably cylindrical in cross-section, and preferably are present or extend throughout the mesoporous material.

The mesoporous structure has a periodic arrangement of pores having a defined, recognisable topology or architecture, for example cubic, lamellar, oblique, centred rectangular, body-centred orthorhombic, body-centred tetragonal, rhombohedral, hexagonal. Preferably, the mesoporous structure has a periodic pore arrangement that is hexagonal, in which the electrode is perforated by a hexagonally oriented array of pores that are of uniform diameter and continuous through the thickness of the electrode.

In the preferred case where the pore arrangement is hexagonal, the arrangement of pores has a regular pore periodicity, corresponding to the centre-to-centre pore spacing, preferably in the range from 3 to 15 nm, more preferably in the range from 5 to 9 nm. The topology of the pores may be selected by known means, for example by adjusting the temperature during the formation process.

Moreover, the mesoporous structure having this regular periodicity and substantially uniform pore size should extend over a portion of the electrode of the order of at least 10 times, preferably at least 100 times, the average pore size. Preferably, the electrode consists of or consists substantially of a structure or structures as defined.

It will be appreciated that these pore topologies are not restricted to ideal mathematical topologies, but may include distortions or other modifications of these topologies, provided recognisable architecture or topological order is present in the spatial arrangement of the pores in the film. Thus, term “hexagonal” as used herein encompasses not only materials that exhibit mathematically perfect hexagonal symmetry within the limits of experimental measurement, but also those with significant observable deviations from the ideal state, provided that most channels are surrounded by an average of six nearest-neighbour channels at substantially the same distance. Similarly, the term “cubic” as used herein encompasses not only materials that exhibit mathematically perfect symmetry belonging to cubic space groups within the limits of experimental measurement, but also those with significant observable deviations from the ideal state, provided that most channels are connected to between two and six other channels.

The electrolyte in the cell is preferably an aqueous electrolyte, for example an aqueous alkaline electrolyte such as aqueous potassium hydroxide or an acidic electrolyte such as aqueous sulphuric acid. Where the redox electrode is one capable of storing charge by lithium insertion or alloying with lithium, non-aqueous electrolytes are preferred. Examples of such electrolytes include lithium hexafluorophosphate and lithium tetrafluoroborate.

The separator may be made of any conventional material and its nature is not critical to the present invention. Preferred materials for use as the separator include microporous polypropylene or polyethylene membrane, porous glass fibre tissue or a combination of polypropylene and polyethylene. The number of separators used will, as is well known, be appropriate to the number of electrodes.

In a preferred embodiment, the mesoporous structure of the redox electrode comprises nickel and an oxide, hydroxide or oxy-hydroxide of nickel selected from NiO, Ni(OH)₂ and NiOOH, said nickel oxide, hydroxide or oxy-hydroxide forming a surface layer over said nickel and extending over at least the pore surfaces, and the double layer electrode is a composite comprising carbon and a binding agent.

The mesoporous materials may be prepared by a liquid crystal templating method, and preferably are deposited as films on a substrate by electrochemical deposition from a lyotropic liquid crystalline phase. They may also be prepared by electro-less deposition, such as by chemical reduction from a lyotropic liquid crystalline phase.

Suitable substrates include gold, copper, silver, aluminium, nickel, rhodium, iron, lead or cobalt, or an alloy containing any of these metals including steel, or phosphorus or alloys of any of these substances with a nickel coating. The substrate may, if desired, be microporous, with pores of a size preferably in the range from 1 to 20 micrometres. The substrate preferably has a thickness in the range from 2 to 250 micrometres. The substrate preferably is a substrate as above, other than gold, having a layer of nickel formed on it by electrodeposition or vapour deposition.

Suitable methods for depositing mesoporous materials as films onto a substrate by electrochemical deposition and chemical means are known in the art. For example, suitable electrochemical deposition methods are disclosed in EP-A-993,512; Nelson, et al., “Mesoporous Nickel/Nickel Oxide Electrodes for High Power Applications”, J. New Mat. Electrochem. Systems, 5, 63-65 (2002); Nelson, et al., “Mesoporous Nickel/Nickel Oxide—a Nanoarchitectured Electrode”, Chem. Mater., 2002, 14, 524-529. Suitable chemical reduction methods are disclosed in U.S. Pat. No. 6,203,925.

Preferably, the mesoporous material is formed by electrochemical deposition from a lyotropic liquid crystalline phase. According to a general method, a template is formed by self-assembly from certain long-chain surfactants and water into a desired liquid crystal phase, such as a hexagonal phase. Suitable surfactants include octaethylene glycol monohexadecyl ether (C₁₆EO₈), which has a long hydrophobic hydrocarbon tail attached to a hydrophilic oligoether head group. Others include the polydisperse surfactants Brij®56 (C₁₆EOₙ where n˜10), Brij®78 (C₁₆EOₙ where n˜20), and Pluronic 123, each available from Aldrich. At high (>30%) aqueous concentrations, and dependent on the concentration and temperature used, the aqueous solution can be stabilised in a desired lyotropic liquid crystal phase, for example a hexagonal phase, consisting of separate hydrophilic and hydrophobic domains, with the aqueous solution being confined to the hydrophilic domain. Dissolved inorganic salts, for example nickel acetate, will also be confined to the hydrophilic domain, and may be electro-reduced at an electrode immersed in the solution, to form a solid mesophase, for example of nickel metal, that is a direct cast of the aqueous domain phase structure. Subsequent removal of the surfactant, by washing in a suitable solvent, leaves a regular periodic array of pores in the electro-reduced solid, the arrangement of the pores being determined by the lyotropic liquid crystal phase selected. The topology, size, periodicity and other pore characteristics may be varied by appropriate selection of the surfactant, solvent, metal salts, hydrophobic additives, concentrations, temperature, and deposition conditions, as is known in the art.

As noted above, the mesoporous material of which the mesoporous electrode is made is preferably formed by electrodeposition or chemical deposition on a substrate. Since the mesoporous material may lack adequate mechanical strength, it is preferably used as an electrode on a substrate, and, for convenience, this is preferably the same substrate as was used in its preparation.

The invention is further illustrated by reference to the following non-limiting Examples.

### EXAMPLE 1

This example demonstrates a cell with a relatively “flat” voltage profile, a high volumetric charge storage capacity and an electrode thickness ratio which lies outside the region indicated as optimal by prior art. Its construction is summarised in Table 1.

TABLE 1

| Ni | C | Electrode | | Cap C (F/cc) | |
|---|---|---|---|---|---|
| Electrode | Electrode | Volume | Cap Ni (F/cc) | (measured | |
| Thickness | Thickness | Ratio | (measured at | at 2092 mA/ | |
| (μm) | (μm) | (C:Ni) | 2092 mA/cm³) | cm³) | Ratio |
| 20 | 250 | 12.5:1 | 1635 | 106 | 15.4 |

### Preparation of the Nickel Cobalt Electrode

### Preparation of Liquid Crystal Mixture

The novel mesoporous nickel cobalt electrode was made by electrodepositing a thin film onto a bare nickel substrate, using a liquid crystal surfactant template. The liquid crystal template for the deposition comprised a mixture of 50 wt. % cetyl trimethylammonium bromide (CTAB) and 50 wt. % of aqueous metal salts. The aqueous metal salt component comprised 70 wt. % nickel chloride hexahydrate solution (1.2M) and 30 wt. % cobalt chloride hexahydrate solution (1.2M).

The two metal salts were first mixed together before subsequent mixing with the CTAB. Mixing was continued for one hour until the mixture was macroscopically homogeneous.

### Preparation of the Nickel Substrate.

10 μm thick nickel foil (Special Metals Wiggin Ltd.) was degreased using acetone prior to deposition of the mesoporous material.

### Preparation of Deposition Cell

The cell used to electrodeposit the mesoporous material was constructed by sandwiching the liquid crystal template between the degreased nickel foil working electrode and a rigid carbon counter electrode, the distance between the two electrodes being 3 mm.

The deposition cell was then placed on a hot plate and heated to 45° C., allowing the hexagonal phase to form.

A potentiostat was then connected to the deposition cell, and potentiostatic deposition was carried out to deposit the mesoporous nickel cobalt material to give the desired charge storage capacity. Charge storage capacity is varied by varying the amount of charge allowed to pass during the deposition.

### Clean Up and Treatment of the Novel Electrode.

Once the electrodeposition finished, the deposited electrode was washed in warm water to remove the CTAB and any unreacted nickel or cobalt salts.

The electrode was then rolled using a rolling mill to a final thickness of 20 μm.

### Analysis of the Electrode.

Galvanostatic cycling in 6 M KOH solution was used to measure the charge storage capacity of the deposited nickel cobalt electrode prior to construction of the supercapacitor. The cycling was performed from 0 V to 0.6 V versus a mercury/mercury oxide reference electrode and a nickel/carbon composite counter electrode was used. The current used to charge and discharge the electrode was 6 mA/cm².

### Supercapacitor Assembly and Testing.

To construct the hybrid supercapacitor the mesoporous nickel cobalt electrode was combined with a polypropylene separator (Celgard 3501), a 250 μm thick carbon electrode (Gore Excellerator) and 6 M KOH electrolyte. The carbon negative electrode was backed by a 10 μm thick nickel foil current collector. The cell was contained within an aluminium based softpack material. To facilitate connection to the cell, nickel tabs were ultrasonically welded onto the nickel cobalt electrode. The mesoporous nickel cobalt electrode, the carbon electrode and the separator all had the same footprint.

Once assembled in the aluminium softpack material, the device was heated to hermetically seal the soft-packaging, totally encasing the electrodes.

The assembled supercapacitor was then cycled between the voltage limits of 1.5 V and 0 V. A constant current of 6 mA was used for charging. The result of a subsequent galvanostatic discharge at a current density of 5220 mA/cm³ is shown in FIG. 1 which shows a plot of voltage versus time. The curve shows a slowly decaying voltage profile lasting for approximately 7 seconds before reaching 0.75V.

The volumetric charge storage capacity for this cell at a discharge rate of 5220 mA/cm³ and in the voltage range 1.5 V to 0.75 V was 9.87 mAh/cm³. The lower voltage limit of 0.75 V was used since charge derived at voltages lower than half of the maximum cell voltage is often unusable in many applications. This is well known in the art.

### EXAMPLE 2

### Comparative

This example demonstrates a cell using an electrode thickness ratio which lies outside the claimed region of the present invention.

The experimental details for this cell were the same as for that of Example 1 with the exception that both the mesoporous positive electrode and carbon negative electrode were thinner. The construction of the cell is summarised in Table 2.

TABLE 2

| Ni | C | Electrode | | Cap C (F/cc) | |
|---|---|---|---|---|---|
| Electrode | Electrode | Volume | Cap Ni (F/cc) | (measured | |
| Thickness | Thickness | Ratio | (measured at | at 2092 mA/ | |
| (μm) | (μm) | (C:Ni) | 2092 mA/cm³) | cm³) | Ratio |
| 10 | 80 | 8:1 | 1635 | 62 | 26.3 |

After charging at 6 mA, the cell was galvanostatically discharged at a current density of 4984 mA/cm³. The discharge profile is shown in FIG. 2. The curve shows a discharge lasting approximately 5.1 seconds before the voltage reaches 0.75V.

The volumetric charge storage capacity for this cell available at a discharge rate of 4984 mA/cm³ and in the voltage range 1.5 V to 0.75 V was 7.07 mAh/cm³. Comparison with FIG. 1 shows that decreasing the electrode volume ratio from 12.5:1 to 8:1 leads to an unacceptably fast reduction in voltage during discharge and a correspondingly low charge storage capacity.

### EXAMPLE 3

### Comparative

### Thick Nickel Electrode

This example demonstrates the performance of a cell with an electrode volume ratio which lies within the region indicated as optimal by the prior art but in a different zone to that in Example 2.

Here, a bi-cell type construction was used in which two carbon electrodes were placed either side of a central nickel electrode. Electrode thicknesses are described in Table 3.

The nickel electrode chosen was a commercially available electrode but in other respects the assembly and testing of the cell was the same as in Examples 1 and 2 with the exception that the discharge was carried out at a slightly different current density of 4986 mA/cm³.

TABLE 3

| Ni | C | Electrode | | Cap C (F/cc) | |
|---|---|---|---|---|---|
| Electrode | Electrode | Volume | Cap Ni (F/cc) | (measured | |
| Thickness | Thickness | Ratio | (measured at | at 2092 mA/ | |
| (μm) | (μm) | (C:Ni) | 2092 mA/cm³) | cm³) | Ratio |
| 320 | 500 | 1.56:1 | 738 | 106 | 6.96 |

FIG. 3 shows a discharge profile with a rapidly decreasing cell voltage such that the discharge above 0.75 V lasts only approximately 2.2 seconds.

The volumetric charge storage capacity for this cell available at a discharge rate of 4986 mA/cm³ and in the voltage range 1.5 V to 0.75 V was 3.05 mAh/cm³. Comparison with FIG. 1 shows that decreasing the electrode volume ratio from 12.5:1 to 1.56:1 leads to an unacceptably fast reduction in voltage during discharge and a correspondingly low charge storage capacity even lower than that shown in Example 2.

### EXAMPLE 4

This example demonstrates a cell, the same as that in Example 1 but at a lower cell discharge rate. The cell exhibits a relatively “flat” voltage profile, a high volumetric charge storage capacity and an electrode thickness ratio which lies outside the region indicated as optimal by prior art. The experimental details for this cell were the same as for that of Example 1. Its construction is summarised in Table 1.

The results are shown in FIG. 4, which shows a plot of voltage versus time. The cell was galvanostatically discharged at a current density of 1400 mA/cm³. The curve effectively shows a flat voltage profile for about 21 seconds. This is very attractive for certain applications.

The volumetric charge storage capacity for this cell available at a discharge rate of 606 mA/cc and in the voltage range 1.5 V to 0.75 V was 10.9 mAh/cc.

1. A hybrid supercapacitor comprising: at least one double layer electrode; at least one redox electrode; current collectors; at least one separator; and an electrolyte, characterised in that the ratio of the total volume of the double layer electrode or electrodes to the total volume of the redox electrode or electrodes is from 9:1 to 100:1.

2. A hybrid supercapacitor according to claim 1, in which the electrodes have similar or the same footprints, and the ratio of the total thickness of the double layer electrode or electrodes to the total thickness of the redox electrode or electrodes is from 9:1 to 100:1.

3. A hybrid supercapacitor according to claim 1 or claim 2, in which the ratio of the total volume of the double layer electrode or electrodes to the total volume of the redox electrode or electrodes is in the range from greater than 9:1 to 100:1.

4. A hybrid supercapacitor according to claim 3, in which the ratio of the total volume of the double layer electrode or electrodes to the total volume of the redox electrode or electrodes is from 10:1 to 100:1.

5. A hybrid supercapacitor according to claim 4, in which the ratio of the total volume of the double layer electrode or electrodes to the total volume of the redox electrode or electrodes is from 10:1 to 50:1.

6. A hybrid supercapacitor according to claim 5, in which the ratio of the total volume of the double layer electrode or electrodes to the total volume of the redox electrode or electrodes is from 15:1 to 50:1.

7. A hybrid supercapacitor according to any one of the preceding claims, in which the ratio of capacitance per unit volume of the double layer electrode to the redox electrode is from 1:10 to 1:20, more preferably from 1:12 to 1:20.

8. A hybrid supercapacitor according to any one of the preceding claims, in which the redox electrode is formed of a mesoporous material.

9. A hybrid supercapacitor comprising: at least one double layer electrode; at least one redox electrode; current collectors; at least one separator; and an electrolyte, characterised in that the redox electrode or electrodes each has a total active layer thickness in the range from 5 to 100 μm.

10. A hybrid supercapacitor according to claim 9, in which the redox electrode or electrodes each has a total active layer thickness in the range from 10 to 70 μm.

11. A hybrid supercapacitor according to claim 9, in which the redox electrode or electrodes each has a total active layer thickness in the range from 10 to 30 μm.
